(19) United States
(12) Patent Application Publication
(10) Pub. No.: US 2006/0199878 A1
(43) Pub. Date: Sep. 7, 2006

(54) THERMAL INTERFACE MATERIAL AND FILLER USED THEREIN

(76) Inventors: Kuang-Cheng Fan, Taipei City (TW); Bar-Long Denq, Taipei City (TW); Fang-Ling Kuo, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/162,905

(22) Filed: Sep. 28, 2005

(30) Foreign Application Priority Data
Mar. 3, 2005 (TW) 94106403

(51) Int. Cl. C08K 9/00; B32B 5/16

(52) U.S. Cl. 523/200; 428/403

(57) ABSTRACT

A filler used in thermal interface materials (TIMs) is disclosed. The filler is composed of a plurality of electrically conductive particles, on which a non-electrically conductive films is formed for preventing the electrically conductive particles from electrical conducting with each other. The present invention also provides a thermal interface material (TIM) including the above-mentioned filler.

### CROSS-REFERENCE TO RELATED APPLICATION

This application claims the priority benefit of Taiwan application serial no. 94106403, filed on Mar. 3, 2005. All disclosure of the Taiwan application is incorporated herein by reference.

### BACKGROUND OF THE INVENTION

1. Field of Invention

The present invention relates to a thermal interface material (TIM) and, more particularly, to a filler used in the thermal interface material.

2. Description of the Related Art

In recent technology, the processing speed and the operation efficiency of a central processing unit (CPU) is substantially enhanced. The major breakthrough is that the linewidth of a CPU chip has reached a 90 nanometer. Along with an increased clock frequency, smaller transistors and a denser chip layout, the number of transistors disposed on a same area has doubled, which results in nearly double heat generation in a same chip area. To facilitate the heat dissipation, normally a cooling component is mounted on the heat-generating component of a CPU. In addition, a thermal interface material (TIM) is applied between the heat-generating component and the cooling component for transferring heat from the heat-generating component to the cooling component. Therefore, the thermal conductivity of the thermal interface material has a direct impact on the thermal dissipation performance of the cooling component.

FIG. 1 is a schematic cross-sectional view of a conventional thermal interface material applied between a heat-generating component 130 and a cooling component 140. Referring to FIG. 1, in general, a TIM 100 is composed of an organic carrier 110 and inorganic high-thermal-conductivity powders 120, wherein the organic carrier 110 carries and supports the inorganic high-thermal-conductivity powders 120. Owing to the elongation and flowing properties of the organic carrier 110, the TIM 100 is able to fill in and pad the gaps and uneven surface of both the heat-generating component 130 and the cooling component 140, respectively. As a result, the heat can be conducted from the heat-generating component 130 to the cooling component 140.

Generally, the inorganic high-thermal-conductivity powders in TIMs can be categorized into metal-oxide ceramics and metal powder. Compared with the metal-oxide ceramics, the metal powder has better thermal conductivity. However, the metal powder is more electrically conductive, and after a period of time, the metal powder may cause short circuits between devices due to deterioration of materials or bad quality. Therefore, the non-electrically conductive inorganic powder, i.e. metal-oxide ceramics is used more often in currently practical applications. Nevertheless, the thermal conductivity of the metal-oxide ceramics is not good enough such that the thermal dissipation performance thereof can't meet the requirement.

### SUMMARY OF THE INVENTION

An object of the present invention is to provide a thermal interface material (TIM) with high thermal conductivity and high dielectric strength without causing short circuit between components.

Another object of the present invention is to provide a filler used in thermal interface materials for forming a thermal interface materials (TIM) with high thermal conductivity and high dielectric strength.

The TIM of the present invention includes a carrier and a filler. The filler comprises a plurality of electrically conductive particles, wherein a non-electrically conductive film is formed on the surface of each electrically conductive particle. The filler occupies 40-95% of total TIM weight.

According to the TIM described in an embodiment of the present invention, the above-mentioned electrically conductive particles have high thermal conductivity and can be made of noble metal, base metal or electrically conductive polymer, such as gold, silver or copper.

According to the TIM described in an embodiment of the present invention, the material of the above-mentioned non-electrically conductive film can be metal oxide, nitride, low-electrically conductive graphite in various types, diamond, low-electrically conductive organic polymer, carbide or metal ceramics. In addition, the thickness of the non-electrically conductive film is, for example, less than the average particle-diameter of the electrically conductive particles. Moreover, the non-electrically conductive film can be formed on the surface of a electrically conductive particle by means of chemical vapor deposition (CVD), physical vapor deposition (PVD), micro-capsule deposition, or oxidation.

According to the TIM described in an embodiment of the present invention, the above-mentioned carrier can be siloxane, silicon oil, mineral oil, epoxy resin, sodium silicate or polyester.

According to the TIM described in an embodiment of the present invention, the above-described filler further includes non-electrically conductive particles. The non-electrically conductive particle can be, for example, metal oxide, nitride, low-electrically conductive graphite in various types, diamond, low-electrically conductive organic polymer, carbide or metal ceramics.

The present invention further provides a filler used in TIMs. The filler includes a plurality of electrically conductive particles and non-electrically conductive films formed on the surfaces of each electrically conductive particle for preventing electric conduction between electrically conductive particles.

According to the filler used in TIMs described in an embodiment of the present invention, the above-described electrically conductive particles have high thermal conductivity and the material thereof can be noble metal, base metal or electrically conductive polymer, such as gold, silver or copper.

According to the filler used in TIMs described in an embodiment of the present invention, the above-described non-electrically conductive particles can be made of metal oxide, nitride, low-electrically conductive graphite in various types, diamond, low-electrically conductive organic polymer, carbide or metal ceramics, and the thickness of the non-electrically conductive film is, for example, less than the average particle-diameter of the electrically conductive particles. In addition, the non-electrically conductive film can be formed on the surface of a electrically conductive particle by means of chemical vapor deposition (CVD), physical vapor deposition (PVD), micro-capsule deposition or oxidation.

By forming a non-electrically conductive or low-electrically conductive film on the surface of each electrically conductive particle, the electrical conductivity of the filler is reduced. Under thermal conductivity and safety considerations, the filler is mixed up with the carrier of TIMs in a certain proportion, so that the required TIM with high thermal conductivity and high dielectric strength is provided.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve for explaining the principles of the invention.

FIG. 1 is a schematic cross-sectional view of a conventional thermal interface material applied between heat-generating components and cooling components.

FIG. 2 is a schematic diagram showing a flowchart for producing a filler used in thermal interface materials according to an embodiment of the present invention.

FIG. 3 is a schematic cross-sectional view of a thermal interface material applied between heat-generating components and cooling components according to an embodiment of the present invention.

### DESCRIPTION OF THE EMBODIMENTS

In the thermal interface material (TIM) of the present invention, electrically conductive particles with high thermal conductivity are preferred. Preferably, the material of the electrically conductive particles in the TIMs of the present invention is noble metal, base metal or electrically conductive polymer. More preferably, the material of the electrically conductive particles is gold, silver or copper. Preferably, the material of the non-electrically conductive film in the TIMs of the present invention is metal oxide, nitride, low-electrically conductive graphite in various types, diamond, low-electrically conductive organic polymer, carbide or metal ceramics. In the TIMs of the present invention, the non-electrically conductive film on the surface of the electrically conductive particle can be formed by any conventional film-forming processes, among which chemical vapor deposition (CVD), physical vapor deposition (PVD), micro-capsule deposition or oxidation are preferred. In addition, the thickness of the non-electrically conductive film is preferably less than the average particle-diameter of the electrically conductive particles. In the thermal interface material (TIM) of the present invention, the carrier can be, but not limited to, any conventional carries used in TIMs. Preferably, the carrier is siloxane, silicon oil, mineral oil, epoxy resin, sodium silicate or polyester. In the thermal interface material (TIM) of the present invention, the filler could further include a plurality of non-electrically conductive particles. The non-electrically conductive particles can be, but not limited to, any conventional non-electrically conductive particles used in TIMs. Preferably, the non-electrically conductive particles is made of metal oxide, nitride, low-electrically conductive graphite in various types, diamond, low-electrically conductive organic polymer, carbide or metal ceramics.

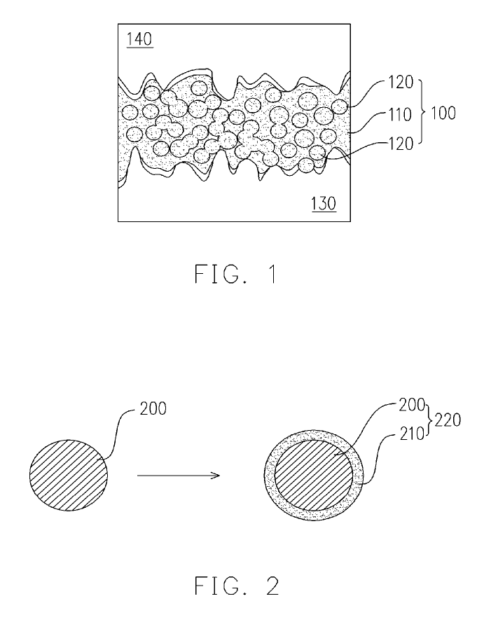

FIG. 2 is a schematic diagram showing a flowchart for producing a filler used in thermal interface materials (TIMs) according to an embodiment of the present invention, wherein only a single particle is shown. However, in an actual application, the filler referred by the invention comprises a plurality of particles.

With reference to FIG. 2, in the embodiment, a non-electrically conductive film 210 without electrical conductivity or with low-electrical conductivity is formed on the surface of the electrically conductive particle 200 by means of chemical vapor deposition (CVD), physical vapor deposition (PVD), micro-capsule deposition, oxidation, or any process capable of adhering a layer of non-electrically conductive compound or a pure substance on the particle surface. The thickness of the non-electrically conductive film 210 is less than the average particle-diameter of the electrically conductive particle 200. The above-described electrically conductive particle 200 can have an irregular shape and high thermal conductivity. The electrically conductive particle 200 can be made of noble metal, base metal or electrically conductive polymer, such as gold, silver or copper. The non-electrically conductive film 210 can be a film of compound or pure substance and made of, for example, metal oxide, nitride, low-electrically conductive graphite in various types, diamond, low-electrically conductive organic polymer, carbide or metal ceramics. In fact, the electrically conductive particle 200 with the non-electrically conductive film 210 covering the surface thereof is the filler 220 of the present invention.

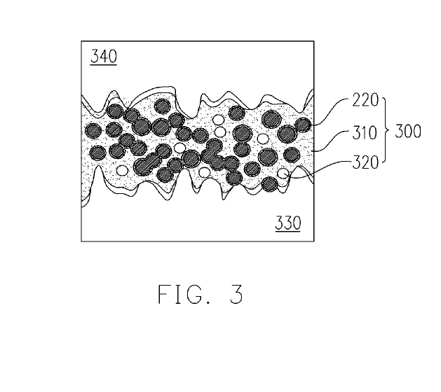

FIG. 3 is a schematic cross-sectional view of a thermal interface material applied between heat-generating components and cooling components according to an embodiment of the present invention, wherein the particles 220 are used as a filler in the TIM 300.

To form the TIM 300 of the present invention, a filler 220 occupying 40-95% of the total TIM weight is solely and evenly mixed up in the organic carrier 310; or as shown in FIG. 3, a filler 220 occupying 40-95% of the total TIM weight and the non-electrically conductive particles 320 in any proportion over the filler 220 are together evenly distributed in the organic carrier 310. Wherein, the non-electrically conductive particles 320 can be metal oxide, nitride, low-electrically conductive graphite in various types, diamond, low-electrically conductive organic polymer, carbide or metal ceramics. By this way, the TIM 300 between the heat-generating component 330 and the cooling component 340 is able to conduct the heat from the heat-generating component 330 to the cooling component 340.

To sum up, the present invention has at least the following advantages:

1. In comparison with the conventional non-electrically conductive filler, the present invention can improve the thermal conductivity by 10 W/m-K or more.

2. In comparison with the conventional electrically conductive filler, the present invention has high dielectric strength of 75 kV/mm or above.

3. Since the present invention forms a layer of non-electrically conductive film on the surface of the electrically conductive particle, the short circuit between the components caused by the TIM can be prevented.

It will be apparent to those skilled in the art that various modifications and variations can be made to the structure of the present invention without departing from the scope or spirit of the invention. In view of the foregoing, it is intended that the specification and examples to be considered as exemplary only, with a true scope and spirit of the invention being indicated by the following claims and their equivalents.

What is claimed is:

1. A thermal interface material (TIM), comprising:
a carrier; and
a filler, formed by a plurality of electrically conductive particles with a non-electrically conductive film on each particle, wherein the filler is 40-95% of the total TIM weight.

2. The thermal interface material (TIM) as claimed in claim 1, wherein the electrically conductive particle has high thermal conductivity.

3. The thermal interface material (TIM) as claimed in claim 1, wherein the material of the conductivity conductive particle is noble metal, base metal or conductivity conductive polymer.

4. The thermal interface material (TIM) as claimed in claim 1, wherein the material of the conductivity conductive particle is gold, silver or copper.

5. The thermal interface material (TIM) as claimed in claim 1, wherein the non-electrically conductive film is made of metal oxide, nitride, low-electrically conductive graphite in various types, diamond, low-electrically conductive organic polymer, carbide or metal ceramics.

6. The thermal interface material (TIM) as claimed in claim 1, wherein the non-electrically conductive film is formed on the surface of the electrically conductive particle by means of chemical vapor deposition (CVD), physical vapor deposition (PVD), micro-capsule deposition or oxidation.

7. The thermal interface material (TIM) as claimed in claim 1, wherein the thickness of the non-electrically conductive film is less than the average particle-diameter of the electrically conductive particles.

8. The thermal interface material (TIM) as claimed in claim 1, wherein the carrier is siloxane, silicon oil, mineral oil, epoxy resin, sodium silicate or polyester.

9. The thermal interface material (TIM) as claimed in claim 1, wherein the filler further includes a plurality of non conductive particles.

10. The thermal interface material (TIM) as claimed in claim 9, wherein the non-electrically conductive particle is metal oxide, nitride, low-electrically conductive graphite in various types, diamond, low-electrically conductive organic polymer, carbide or metal ceramics.

11. A filler used in thermal interface materials (TIMs), comprising:
a plurality of electrically conductive particles; and
a non-electrically conductive film, formed on the surface of the electrically conductive particle to prevent electric conduction between the electrically conductive particles.

12. The filler used in thermal interface materials (TIMs) as claimed in claim 11, wherein the electrically conductive particles have high thermal conductivity.

13. The filler used in thermal interface materials (TIMs) as claimed in claim 11, wherein the material of the electrically conductive particle is noble metal, base metal or conductive polymer.

14. The filler used in thermal interface materials (TIMs) as claimed in claim 11, wherein the material of the electrically conductive particle is gold, silver or copper.

15. The filler used in thermal interface materials (TIMs) as claimed in claim 11, wherein the non-electrically conductive film is made of metal oxide, nitride, low-electrically conductive graphite in various types, diamond, low-electrically conductive organic polymer, carbide or metal ceramics.

16. The filler used in thermal interface materials (TIMs) as claimed in claim 11, wherein the nonconductive film is formed on the surface of the conductive particle by means of chemical vapor deposition (CVD), physical vapor deposition (PVD), micro-capsule deposition or oxidation.

17. The filler used in thermal interface materials (TIMs) as claimed in claim 11, wherein the thickness of the nonconductive film is less than the average particle-diameter of the conductive particle.
